(19) United States
(12) Patent Application Publication
(10) Pub. No.: US 2014/0150757 A1
(43) Pub. Date: Jun. 5, 2014

(54) INTAKE AIR MODULE OF AN INTERNAL COMBUSTION ENGINE

(71) Applicant: GM GLOBAL TECHNOLOGY OPERATIONS LLC, DETROIT, MI (US)

(72) Inventor: Hans H. Drangel, Stockholm (SE)

(73) Assignee: GM GLOBAL TECHNOLOGY OPERATIONS LLC, DETROIT, MI (US)

(21) Appl. No.: 14/049,067

(22) Filed: Oct. 8, 2013

(30) Foreign Application Priority Data
Oct. 10, 2012 (GB) 1218132.7

(51) Int. Cl. F02M 25/07

(52) U.S. Cl. CPC F02M 25/07
USPC 123/568.11

(57) ABSTRACT

An embodiment of the invention provides a device for distributing and mixing an intake air for an internal combustion engine, comprising an intake manifold connected with an intake air cooling channel and a bypass channel, wherein the intake manifold is provided with an EGR distribution pipe, wherein the EGR distribution pipe, the intake air cooling channel and the bypass channel are arranged to each other in such a way that a first air flow from the intake air cooling channel and a second air flow from the bypass channel pass around the EGR distribution pipe along the same flow direction.

### TECHNICAL FIELD

The present disclosure relates to a device, specifically an intake air module of an internal combustion engine (ICE), wherein such device provides the distribution of the air coming from the external ambient into the cylinders of the ICE and contemporary realizes a good mixing between the air flow and the exhaust gas recirculated in an intake manifold.

### BACKGROUND

An internal combustion engine, particularly a highly efficient diesel engine is normally provided with an exhaust gas after-treatment system, for degrading and/or removing the pollutants from the exhaust gas emitted by the Diesel engine, before discharging it in the environment.

The after-treatment system generally comprises an exhaust line for leading the exhaust gas from the Diesel engine to the environment, a Diesel Oxidation Catalyst (DOC) located in the exhaust line, for oxidizing hydrocarbon (HC) and carbon monoxides (CO) into carbon dioxide (CO₂) and water (H₂O), and a Diesel Particulate Filter (DPF) located in the exhaust line downstream the DOC, for removing diesel particulate matter or soot from the exhaust gas.

Another well-known exhaust gas after-treatment system of a Diesel engine is the Lean NOₓ Trap (LNT), which is provided for trapping nitrogen oxides NOₓ contained in the exhaust gas and is located in the exhaust line.

To further reduce the emissions content, in particular NOx emissions, normally Diesel engines include an exhaust gas recirculation (EGR) system coupled between the exhaust system and the intake system. This embodiment is also called a high pressure exhaust gas recirculation (HP-EGR). As known, the EGR works by recirculating a portion of an engine's exhaust gas back to the engine cylinders. In a diesel engine, the exhaust gas replaces some of the excess oxygen in the pre-combustion mixture. Because NOx forms primarily when a mixture of nitrogen and oxygen is subjected to high temperature, the lower combustion chamber temperatures caused by EGR reduces the amount of NOx the combustion generates. More recent embodiments also include a low pressure EGR system (LP-EGR) characterized by a “long route” of the exhaust gases. In this case the additional EGR valve will recirculate the exhaust gases downstream the aftertreatment devices towards the compressor inlet. The operating principle of the LP-EGR is the same as the HP-EGR, with the further advantage that the LP-EGR recirculates exhaust gases at still lower temperature.

Further, even if the majority of the engines comprise an intercooler, which is located upstream the intake system, recently the air intake system is also designed according to an architecture with an air cooling channel integrated into the intake system, replacing the above intercooler. This is done to reduce the volume of the intake system between compressor and intake valve. This architecture is used for both LP-EGR and high pressure EGR (HP-EGR). With this new architecture it is difficult to achieve a good mixing of the HP-EGR, since it has to be mixed after the air cooling channel to avoid fouling of the cooler element. This means that the EGR mixing length before the intake valve becomes very short.

Another feature that is going to be used in modern engines is to provide into the air system a bypass channel, in order to control the temperature of the air into the engine. The combination of all these functions creates a severe issue, since the air flowing into the engine, when a HP-EGR is used, needs to have the same flow direction of the EGR flow, otherwise it is difficult to achieve good mixing of EGR if the air is in by-pass mode.

Therefore a need exists, for such architectures of the air system, to guarantee in all operating conditions a good mixing between intake air and EGR.

An object of this invention is to provide a device, specifically a new intake air module, having a geometry which provides an outcoming air flow along the EGR distribution pipe and guarantees a good mixing between air and EGR, independent on the fact that the air is flowing inside the air cooling channel or the bypass channel.

These objects are achieved by a device, by an engine and by an automotive system having the features recited in the independent claims.

The dependent claims delineate preferred and/or especially advantageous aspects.

### SUMMARY

An embodiment of the disclosure provides a device for distributing and mixing an intake air of an internal combustion engine, comprising an intake manifold connected with an intake air cooling channel and a bypass channel, wherein the intake manifold is provided with an EGR distribution pipe, wherein the EGR distribution pipe, the intake air cooling channel and the bypass channel are arranged to each other in such a way that a first air flow from the intake air cooling channel and a second air flow from the bypass channel are passing around the EGR distribution pipe under the same flow direction.

An advantage of this embodiment is to guarantee under whatever operating condition a good mixing between air and EGR, independent on the fact that the air is flowing inside the air cooling channel or the bypass channel. A further advantage of this embodiment is that such device or intake air module allows to reduce the volume of the whole intake air system between compressor and intake valve.

According to another embodiment, said intake manifold comprises a plenum, wherein the EGR distribution pipe is arranged, and a plurality of air intake runners.

An advantage of this embodiment is to provide a good mixing between air and EGR along the air intake runners, each of them connected with one of the cylinders of the engine.

According to an aspect of the invention, said EGR distribution pipe comprises a plurality of equal spaced holes, throughout the whole EGR distribution pipe length.

This aspect also contributes to a good and homogeneous mixing between air and EGR, due to the symmetrical geometry of the EGR distribution pipe.

According to another aspect, said EGR distribution pipe comprises a plurality of holes, which are equally spaced in the areas of the intake runners.

This alternative geometry of the EGR distribution pipe guarantees a good mixing between air and EGR in each of the air intake runners connected to each cylinder of the engine.

According to another embodiment, the intake air cooling channel and the bypass channel are commonly connected with an air intake duct.

An advantage of this embodiment is to allow a flow connection between the air intake duct and, alternatively, the air cooling channel or the air bypass channel.

According to a still further embodiment, the device further comprises an air distribution device for portioning an intake air flow from the air intake duct between the intake air cooling channel and the bypass channel.

An advantage of this embodiment is that is possible to portion the intake air flow between the air cooling channel and the air bypass channel.

According to an aspect of this embodiment, the air distribution device comprises a first control valve, controlling the intake air flow to the intake air cooling channel.

An advantage of this aspect is to control the air flow amount in the air cooling channel.

According to another aspect of this embodiment, the air distribution device comprises a second control valve, controlling the incoming air flow to the bypass channel.

An advantage of this aspect is to control the air flow amount in the air bypass channel, as well.

According to a further aspect of this embodiment, the air distribution device comprises a two-way valve connected with the intake air cooling channel and the bypass channel, controlling the intake air portioning between said channels.

An advantage of this aspect is to allow full flexibility within the described device to blend hot air from the bypass channel with cold air from the air cooling channel and still blend HP-EGR and LP-EGR in any preferred amount of each.

According to a further embodiment, an internal combustion engine of an automotive system is provided, the engine comprising a device according to one of the previous embodiments.

According to a still further embodiment, an automotive system is provided, the automotive system comprising an internal combustion engine and an electronic control unit configured for managing the air distribution device.

### BRIEF DESCRIPTION OF THE DRAWINGS

The various embodiments will now be described, by way of example, with reference to the accompanying drawings, in which:

FIG. 1 shows an automotive system.

FIG. 2 is a section of an internal combustion engine belonging to the automotive system of FIG. 1.

FIG. 3 is a scheme of an internal combustion engine comprising an intake air module, which integrates an air cooling channel and a bypass channel.

FIG. 4 shows the air flow through the air cooling channel (FIG. 4a) and through the bypass channel (FIG. 4b), according to a known solution.

FIG. 5 schematically shows a front view of the air cooling channel, the bypass channel, the intake manifold, the EGR distribution pipe and their integration into the intake air module, according to an embodiment of the present invention.

FIG. 6 schematically shows a top view of the intake air module and its components as from FIG. 5.

FIG. 7 schematically shows the air flux lines through the air cooling channel and the bypass channel and the mixing between the air and the EGR, according to the present invention.

FIG. 8 shows more in detail the air flow through the bypass channel.

FIG. 9 shows an alternative actuation of the EGR distribution pipe.

### DETAILED DESCRIPTION OF THE DRAWINGS

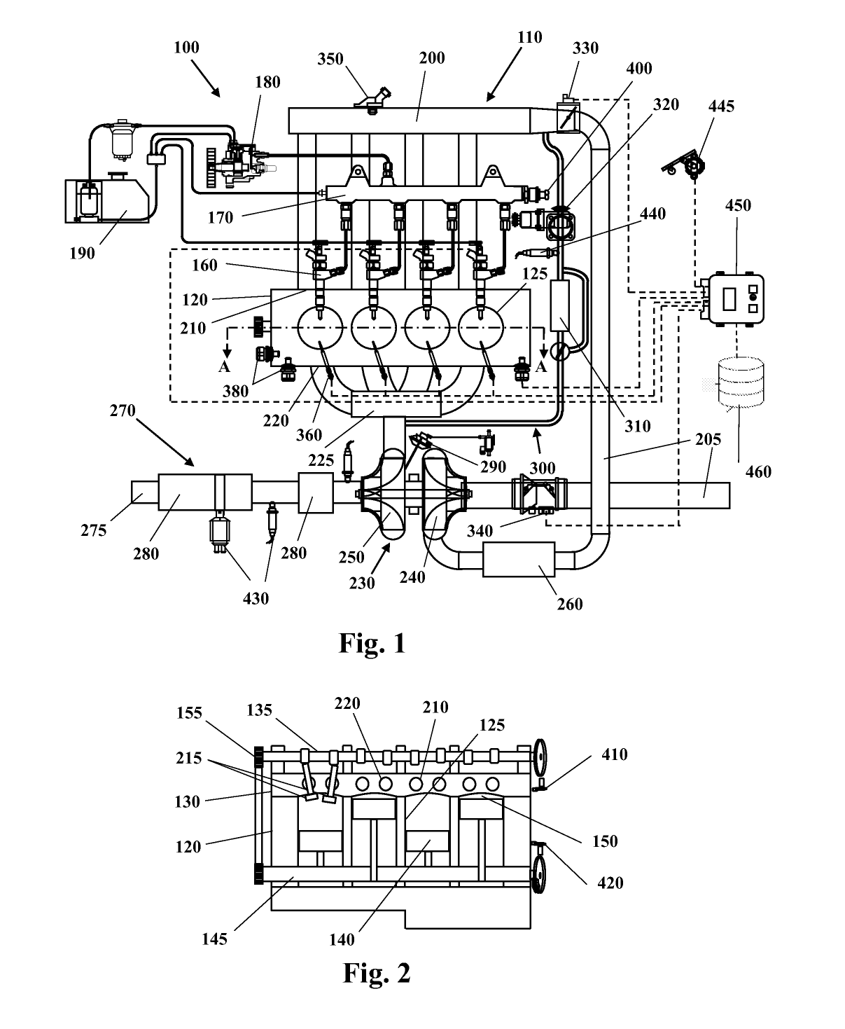

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) 250 with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts 281, lean NOx traps, hydrocarbon adsorbers, selective catalytic reduction (SCR) systems, particulate filters (DPF) 282 or a combination of the last two devices, i.e. selective catalytic reduction system comprising a particulate filter (SCRF). Some embodiments include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300. Still other embodiments (FIG. 3) may include a low pressure EGR system (LP-EGR) characterized by a “long route” of the exhaust gases. In this case an additional low pressure EGR valve 325 will recirculate the exhaust gases downstream the aftertreatment devices towards the compressor 240 inlet. Moreover, a low pressure EGR-cooler 326 can be provided.

The automotive system 100 may further include an electronic control unit (ECU) 450 in communication with one or more sensors and/or devices associated with the ICE 110 and equipped with a data carrier 460. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

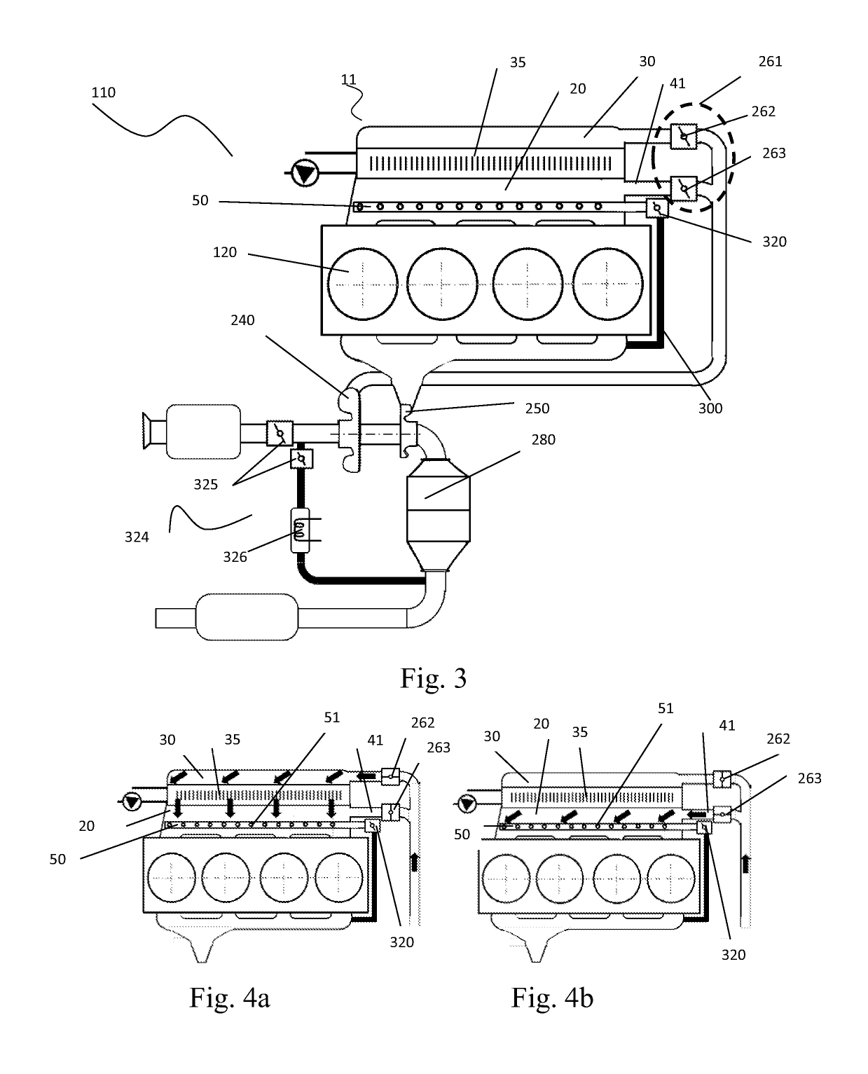

The present invention is related to a device 1, specifically an intake air module comprising an air cooling channel integrated in it. For sake of clarity, before analyzing such device, it will be useful to introduce (with reference to FIGS. 3 and 4) a state of art intake air module 11. The architecture comprising an air intake module, with an air cooling channel integrated in it, is realized to reduce the volume of the whole intake system between compressor 240 and intake valve 210, since the intercooler 260 (as in FIG. 1) can be eliminated. This architecture can be used for both LP-EGR and high pressure EGR (HP-EGR). With this new architecture it is difficult to achieve good mixing of HP-EGR, since it has to be mixed after the intercooler to avoid fouling of the cooler element. This means that the EGR mixing length before the intake valve becomes very short. One solution chosen is to use a EGR distribution pipe 50 with several holes.

Another feature that is going to be used in modern engines is to incorporate into the air intake module an air bypass channel 40, in order to control the temperature of the air into the engine. The combination of all these functions creates a severe issue, since the air flowing into the engine, when a HP-EGR is used, needs to have the same flow direction of the EGR flow, otherwise it is difficult to achieve good mixing of EGR if the air flows through the bypass channel.

In FIG. 3, a scheme of the above architecture is showed. In particular the intake air module 11 is depicted, comprising an air cooling channel 30, comprising a cooler 35 and a bypass channel 41. Such architecture can comprise a different intake manifold 20 and an air distribution device 261 for portioning an incoming air flow from the air intake duct 205 between the intake air cooling channel 30 and the bypass channel 41. Advantageously, the air distribution device can include a first control valve 262, controlling the incoming air flow to the intake air cooling channel 30 and/or a second control valve 263, controlling the incoming air flow to the bypass channel 41. Alternatively, the air distribution device can include a two-way valve connected with the intake air cooling channel 30 and the bypass channel 40, controlling the incoming air portioning between said channels. All these embodiments contribute to create a fully flexible blend between cold air at the exit of the air cooling channel and hot air at the exit of the bypass channel. Moreover, the engine 110 uses both a HP-EGR system 300, recirculating gas from the exhaust to the intake manifold, and a LP-EGR system 325, recirculating gas downstream the aftertreatment system 280 to the compressor 240 inlet.

In FIG. 4 is shown how a known air and EGR system operates. When all air flows through the air cooling channel (FIG. 4a), in other words the bypass channel is closed, the air routes through the air cooling channel and is mixed with the HP-EGR in the EGR distribution pipe 50, located downstream in the intake manifold 20. In fact, the air flows along the holes 51 of the EGR distribution pipe 50. This is a preferred solution for HP-EGR mixing when the air cooling channel 30 is integrated in the intake air module 11, due to the short mixing length after the air cooling channel. On the opposite case, in the case the air cooling channel 30 is fully closed and the bypass channel 41 is fully open, all air flows through the bypass channel 41. Unfortunately, in this case (FIG. 4b) the mixing between HP-EGR and air along the EGR distribution pipe is difficult to achieve: in fact, looking at FIG. 4b, the cylinder located on the right of the picture will receive a lower EGR rate, while the cylinder located on the left of the same picture will get a higher EGR rate. Consequently, no equal EGR mixing is available for all cylinders. In conclusion, the main problem of this architecture is that the HP-EGR distribution pipe 50 has to comply with two different air paths depending on the fact the air cooling channel 30 is used or bypassed. This is the technical problem, the present invention aims to solve.

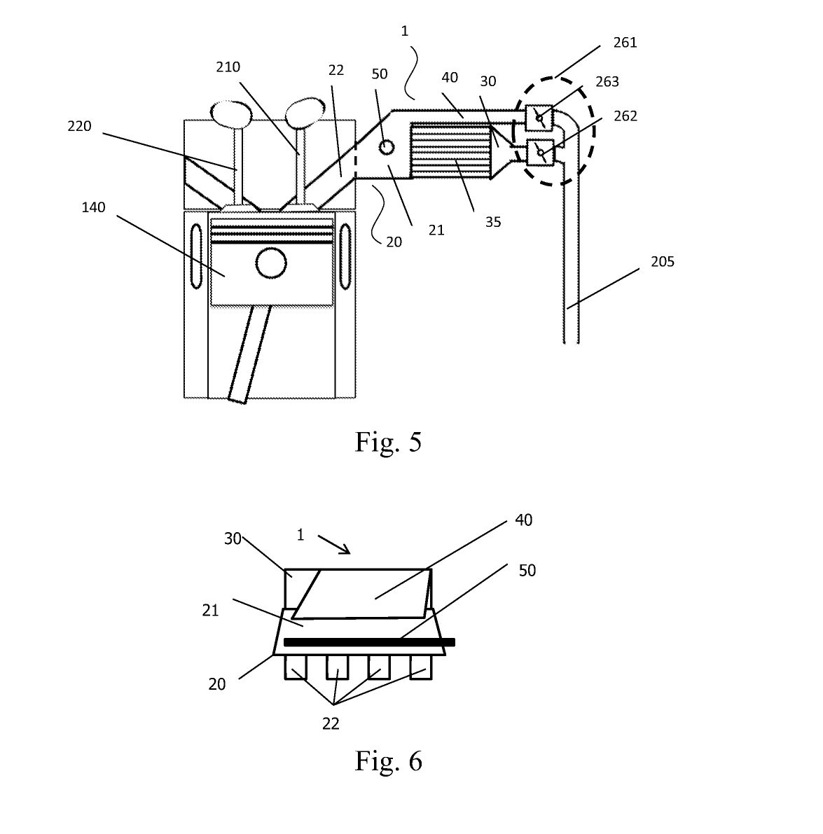

The solution to the mentioned problem, according to the present invention, a new device 1, i.e. a new air intake module, is shown in FIG. 5, which shows a front view in FIG. 6, which schematically shows a top view.

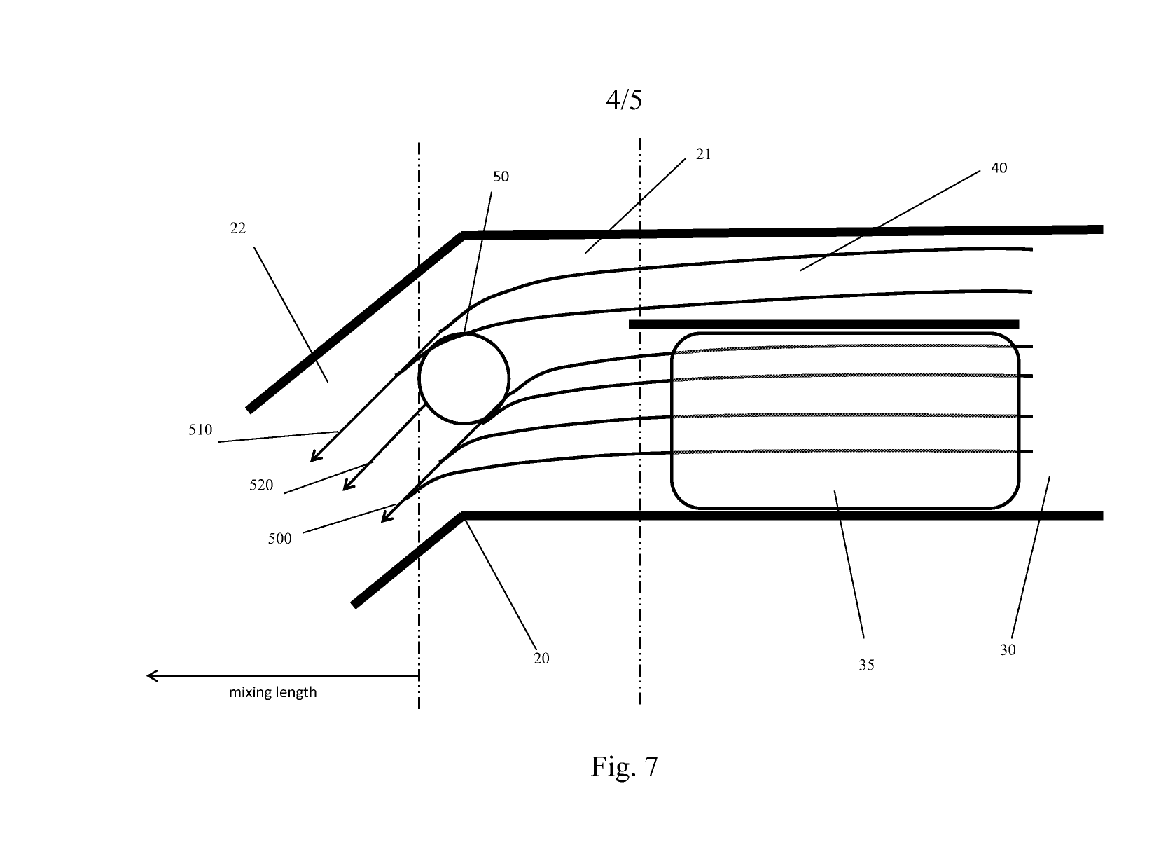

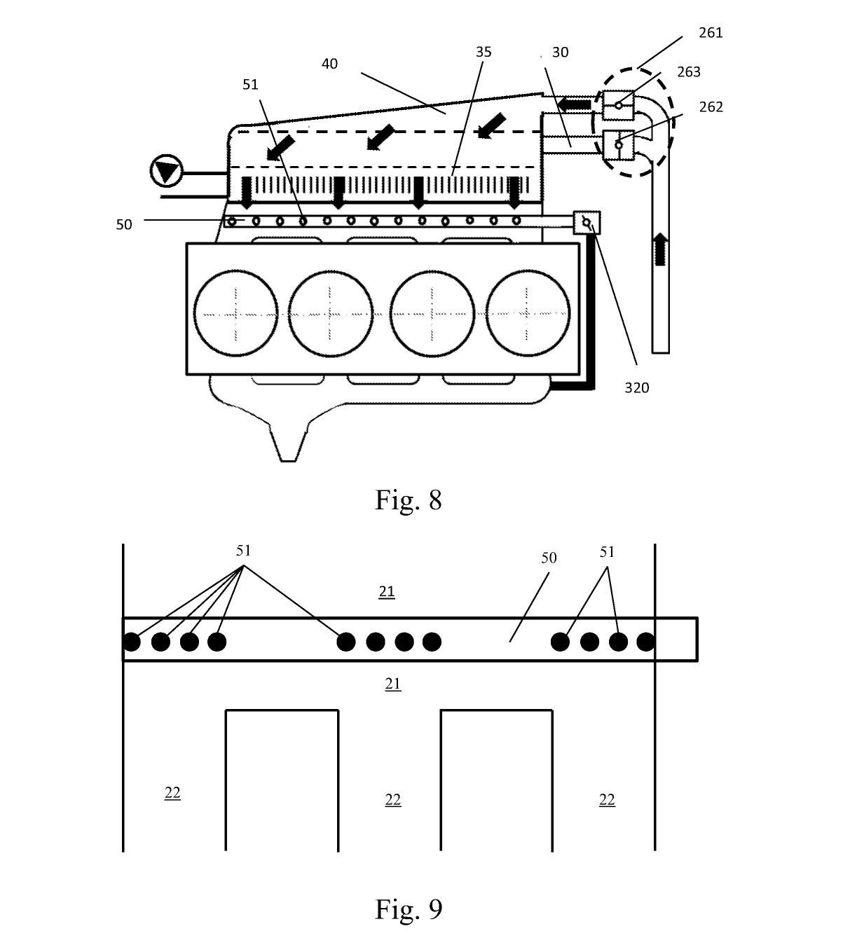

The device 1 for mixing the incoming air comprises an intake manifold 20 connected with an intake air cooling channel 30, comprising a cooler 35, and a bypass channel 40. The intake manifold 20 is provided with an EGR distribution pipe 50, wherein the EGR distribution pipe 50, the intake air cooling channel 30 and the bypass channel 40 are arranged to each other in such a way that a first air flow from the intake air cooling channel 30 and a second air flow from the bypass channel 40 are passing around the EGR distribution pipe 50 under the same flow direction. The inventive concept can be appreciated in FIG. 7, which more schematically shows: flux lines of the air coming from the cooling channel 500, flux lines of the air coming from the bypass channel 510 and EGR flux lines 520. This makes easier to create a good mixing between air and EGR independent on the fact the air cooling channel 30 is used or bypassed. In fact, as shown in FIG. 8, with this new solution, when the air cooling channel 30 is closed and all air flows through the bypass channel 40, the air is routed in a similar way as when the air cooling channel 30 is used (see FIG. 4a) and exits the bypass channel 40 in the same direction (i.e. the flux lines of the air coming from the bypass channel 510 are parallel to flux lines of the air coming from the air cooling channel 500 and both are parallel to the EGR flux lines 520), making it possible to mix EGR within the EGR distribution pipe 50.

According to a preferred solution the intake manifold 20 comprises a plenum 21, wherein the EGR distribution pipe 50 is arranged, and a plurality of air intake runners 22 connecting such plenum to the intake port of each cylinder of the engine. It is to be understood that the mixing length for air and EGR almost corresponds to the length of the air intake runners 22. Therefore, a good mixing between air and EGR is reached along the air intake runners, so providing the same mixing condition for each cylinder of the engine.

Another preferred actuation of the invention provides that the EGR distribution pipe 50 comprises a plurality of equal spaced holes 51, throughout the whole EGR distribution pipe 50 length, thus further improving the homogeneous mixing between air and EGR due to this symmetrical geometry of the EGR distribution pipe. Alternatively, the EGR distribution pipe 50 can comprise a plurality of holes 51, which are equally spaced in the areas of the intake runners 22. With an almost equivalent efficiency, this embodiment provides a good mixing between air and EGR along the air intake runners 22, each of them connected with one of the cylinders of the engine.

In the air intake module 1 a common flow communication between the intake air cooling channel 30 and the bypass channel 40 with the air intake duct 205 is foreseen.

According to a preferred actuation of the invention, the device can comprise an air distribution device 261 for portioning an incoming air flow from the air intake duct 205 between the intake air cooling channel 30 and the bypass channel 40. The air distribution device 261 is part of the intake air module 1 or at least connected to it. Advantageously, the air distribution device 261 can include a first control valve 262, controlling the intake air flow to the intake air cooling channel 30 and/or a second control valve 263, controlling the intake air flow to the bypass channel 40. Alternatively, the air distribution device can include a two-way valve connected with the intake air cooling channel 30 and the bypass channel 40, controlling the intake air portioning between said channels. All these embodiments contribute to create a fully flexible blend between cold air at the exit of the air cooling channel and hot air at the exit of the bypass channel.

Therefore, the geometry of such device enables a robust system when a bypass channel 40 is used together with the HP-EGR system 300 and an air cooling channel 30 is integrated into such intake air module 1. This invention allows full flexibility within the described system to blend hot air from the by-pass with cold air from the intercooler and still blend HP-EGR and LP-EGR in any preferred amount of each. All four parameters can be mixed without restriction.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A device for distributing and mixing an intake air of an internal combustion engine, comprising an intake manifold connected with an intake air cooling channel and a bypass channel, wherein the intake manifold is provided with an exhaust gas recirculation (EGR) distribution pipe, wherein the EGR distribution pipe, the intake air cooling channel and the bypass channel are arranged so that a first air flow from the intake air cooling channel and a second air flow from the bypass channel pass around the EGR distribution pipe along the same flow direction.

2. The device according to claim 1, wherein said intake manifold comprises a plenum, where the EGR distribution pipe is arranged, and a plurality of air intake runners.

3. The device according to claim 1, wherein said EGR distribution pipe comprises a plurality of equal spaced holes, throughout the whole EGR distribution pipe length.

4. The device according to claim 2, wherein said EGR distribution pipe comprises a plurality of holes, which are equally spaced in the areas of the intake runners.

5. The device according to claim 1, wherein the intake air cooling channel and the bypass channel are commonly connected with an air intake duct.

6. The device according to claim 5, further comprising an air distribution device for portioning an intake air flow from the air intake duct between the intake air cooling channel and the bypass channel.

7. The device according to claim 6, wherein the air distribution device comprises a first control valve controlling the intake air flow to the intake air cooling channel.

8. The device according to claim 7, wherein the air distribution device comprises a second control valve controlling the intake air flow to the bypass channel.

9. The device according claim 6, wherein the air distribution device comprises a two-way valve connected with the intake air cooling channel and the bypass channel controlling the intake air portioning between said channels.

10. An internal combustion engine for an automotive system, the engine comprising a device for distributing and mixing an intake air for the internal combustion engine comprising an intake manifold connected with an intake air cooling channel and a bypass channel, wherein the intake manifold is provided with an exhaust gas recirculation (EGR) distribution pipe, wherein the EGR distribution pipe, the intake air cooling channel and the bypass channel are arranged so that a first air flow from the intake air cooling channel and a second air flow from the bypass channel pass around the EGR distribution pipe along the same flow direction.

11. An automotive system comprising an internal combustion engine and an electronic control unit configured for managing an air distribution device, said engine comprising an air intake device including the air distribution device for distributing and mixing an intake air for the internal combustion engine, said air intake device comprising an intake manifold connected with an intake air cooling channel and a bypass channel, wherein the intake manifold is provided with an exhaust gas recirculation (EGR) distribution pipe, wherein the EGR distribution pipe, the intake air cooling channel and the bypass channel are arranged so that a first air flow from the intake air cooling channel and a second air flow from the bypass channel pass around the EGR distribution pipe along the same flow direction, said air distribution device portioning an intake air flow from an air intake duct between the intake air cooling channel and the bypass channel.

12. The engine according to claim 10, wherein said intake manifold comprises a plenum where the EGR distribution pipe is arranged, and a plurality of air intake runners.

13. The engine according to claim 10, wherein said EGR distribution pipe comprises a plurality of equal spaced holes, throughout the whole EGR distribution pipe length.

14. The engine according to claim 12, wherein said EGR distribution pipe comprises a plurality of holes, which are equally spaced in the areas of the intake runners.

15. The engine according to claim 12, wherein the intake air cooling channel and the bypass channel are commonly connected with the air intake duct.

16. The system according to claim 11, wherein the air distribution device comprises a first control valve for controlling the intake air flow to the intake air cooling channel.

17. The system according to claim 16, wherein the air distribution device comprises a second control valve for controlling the intake air flow to the bypass channel.

18. The system according claim 11, wherein the air distribution device comprises a two-way valve connected with the intake air cooling channel and the bypass channel for controlling the intake air portioning between said channels.
